(19) United States
(12) Patent Application Publication
(10) Pub. No.: US 2024/0236150 A1
(43) Pub. Date: Jul. 11, 2024

(54) METHOD AND SYSTEM FOR ON DEMAND DEFENSE-IN-DEPTH SECURITY POLICY TRANSLATION AND ENFORCEMENT

(71) Applicants: Rahul Arvind Jadhav, Bangalore (IN); Achref Ben Saad, Elhouaria (TN); Ankur Kothiwal, Pradesh (IN)

(72) Inventors: Rahul Arvind Jadhav, Bangalore (IN); Achref Ben Saad, Elhouaria (TN); Ankur Kothiwal, Pradesh (IN)

(73) Assignee: Accuknox, Inc., Cupertino, CA (US)

(21) Appl. No.: 18/406,113

(22) Filed: Jan. 6, 2024

Related U.S. Application Data
(60) Provisional application No. 63/428,262, filed on Jan. 6, 2023.

(51) Int. Cl. H04L 9/40

(52) U.S. Cl. CPC H04L 63/205; H04L 63/10

(57) ABSTRACT

The embodiments herein provide a method and system for on demand defense-in-depth security policy translation and enforcement involving deriving one or more input security policies related to one or more policy engines from one or more security intents with an input module; creating an intermediate representation related to one or more security intents of one or more input security policies with an intermediate representation module; identifying one or more target policies operating in a target environment with an output module; converting the intermediate representation into one or more target policies; identifying one or more security intents, denied by one or more target policies; and creating an alert, optionally, for the security team to identify the difference, if one or more security intents are denied by one or more target policies while converting or translating the intermediate representation into one or more target policies.

### CROSS-REFERENCE TO RELATED APPLICATIONS

The present application claims the priority of the U.S. Provisional Patent Application (PPA) with Ser. No. 63/428,262 filed on Jan. 6, 2023 with the title “A METHOD AND SYSTEM FOR ON DEMAND DEFENSE-IN-DEPTH SECURITY POLICY TRANSLATION AND ENFORCEMENT”, and the contents of which PPA are included in their entirety as reference herein.

### BACKGROUND

### Technical Field

The embodiments herein, in general, relate to security policy enforcement. More particularly, the embodiments herein relate to a method and a system for on-demand defense-in-depth security policy translation and enforcement.

### Description of the Related Art

As media on differing networks are being converged, a challenge is presented in keeping a consistent security policy from one end to the other. So today when someone deploys a security engine, one has to deploy policies in the context of that security engine i.e., the policies are tightly tied to the underlying policy engine. For instance, for Cilium it is CiliumNetworkPolicy; for Calico, it is CalicoNetworkPolicy hence each security engine has its own policy specification.

There have been efforts to standardize the policy language such that different policy engines could make use of the same constructs to enforce the policies. For instance, k8s network policy, the Network Policy engines support a common policy format. However, the format does not have all the constructs supported by individual policy engines, and thus individual policy engines end up defining their own constructs. Similarly, for Service Mesh, there exists something called SMI-spec that provides a standard interface for service meshes on k8s. However, every service mesh solution has extended on top of the standard interface and provides its own specifications.

Therefore, in general, the problem with standard interfaces is that they cannot keep up with the advancements in the policy rules construct. For instance, consider an organization that has deployed Calico as the network policy engine and using KubeArmor for runtime protection. Calico provides the ability to protect from network threats by enforcing ingress and egress rules, while KubeArmor protects the application runtime, by allowing only certain processes to use certain network primitives such as TCP/UDP sockets. Consider the case where the organization decides to switch from Calico to Cilium for the network policy engine. Currently, the security team has to manually convert the Calico rules to Cilium. This results in a vendor-dependent ecosystem.

Therefore, Currently, there does not exist a systematic way to communicate a security policy from one deployment to another. This is largely caused by the fact that the security policies deployed on each deployment are often incompatible with each other. The result of such incompatibility is that security is available only in part of the converged, heterogeneous network. Thus, security holes are created in various end-to-end scenarios.

A challenge of achieving end-to-end security policy is that a network can only speak and understand its own security policy and has little knowledge of the security policy of a connected network. As the number of interconnected networks increases, the level of difficulty in achieving an end-to-end, consistent security policy increases substantially, if not exponentially.

A further challenge of achieving end-to-end security policy is that network security policies are network-specific and different from one another. In addition, specific implementations within a security policy may be local to a particular network, and subsequently may not be directly transported to a different network. Additionally, the enforcement mechanism for one network often cannot be used for a different network.

Hence, there is a long-felt need for a method and a system for on-demand defense-in-depth security policy translation and enforcement, by converting any existing policy constructs into a common rules language (but not necessarily standardized) and then converting it into target policy engines format, while addressing the above-recited problems associated with the related art.

The above-mentioned shortcomings, disadvantages, and problems are addressed herein, and will be understood by reading and studying the following specification.

### OBJECTIVES OF THE EMBODIMENTS HEREIN

The principal object of the embodiment herein is to provide a method and system for on-demand defense-in-depth security policy translation and enforcement.

Another object of the embodiment herein is to provide a method for converting an input intent from any to any other format by first converting the input intent into an intermediate representation.

Yet another object of the embodiment herein is to convert the intermediate representation into a target format.

Yet another object of the embodiment herein is to utilize the Kubernetes operator or admission controller or K8s operator policy converter for converting one or more input intents/policies to the one or more target policies, from one format to another during deployment time.

Yet another object of the embodiment herein is to optionally, create an alert for the security team to identify the delta/difference if some of the rules or one or more security intents are not supported by one or more target policies while converting or translating the intermediate representation into the one or more target policies.

Yet another object of the embodiment herein is to create multiple policies that could be enforced by different policy engines given the security intent.

These and other objects and advantages of the present invention will become readily apparent from the following detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

This Summary is provided to introduce a selection of concepts in a simplified form that is further described below in the Detailed Description. This Summary is not intended to identify key or essential features of the claimed subject matter, nor is it intended to be used as an aid in determining the scope of the claimed subject matter.

The various embodiments herein provide a method and system for on-demand defense-in-depth security policy translation and enforcement. The embodiments herein involve converting an input security policy from any to any other format by first converting the input security policy into an intermediate representation. The intermediate representation is a way of representing the security intent. Further, converting the intermediate representation into a target policy format.

According to one embodiment herein, a method for on-demand defense-in-depth security policy translation and enforcement is provided. The method comprises deriving one or more input security policies related to one or more policy engines from one or more security intents. The method further involves creating an intermediate representation related to one or more security intents of one or more input security policies. In addition, the method involves identifying one or more target policies operating in a target environment. The method further involves converting the intermediate representation into one or more target policies. Furthermore, the method involves identifying one or more security intents, that are denied by one or more target policies, and creating an alert, optionally, for the security team to identify the difference, if one or more security intents are denied by one or more target policies while converting or translating the intermediate representation into one or more target policies.

According to one embodiment herein, one or more security intents are a high-level abstraction resulting in one or more target policies that are enforceable by one or more policy engines.

According to one embodiment herein, the intermediate representation is a significant way to obtains the inputs from a user in a machine-readable format.

According to one embodiment herein, while converting one or more input security policies to one or more target policies, from one format to another during deployment time, the method utilizes the Kubernetes operator, admission controller, or K8s operator policy converter.

According to one embodiment herein, the method for converting the intermediate representation into one or more target policies is provided. The method involves deploying a security intent operator in the target environment. The method further involves running one or more security intents through multiple policy engine adapters by the security intent operator, to check if there are one or more target policies in the context of one or more security intents specified by the user. In addition, the method involves returning one or more target security policies to the security intent operator if one or more target policies are available for one or more security intents.

According to one embodiment herein, a system for on-demand defense-in-depth security policy translation and enforcement is provided. The system comprises an input module configured to derive one or more input security policies related to one or more policy engines from one or more security intents. Further, the system comprises an intermediate representation module configured to receive one or more input security policies from the input module and further configured to create an intermediate representation related to one or more security intents of one or more input security policies. Moreover, the system comprises an output module configured to receive the intermediate representation, from the intermediate representation module, and further configured to identify one or more target policies operating in a target environment. The output module is further configured to convert the intermediate representation into one or more target policies. Moreover, the output module is also configured to identify one or more security intents, that are denied by one or more target policies, and optionally create an alert for the security team to identify the difference, if one or more security intents are denied by one or more target policies while converting or translating the intermediate representation into one or more target policies.

According to one embodiment herein, one or more security intents of the input module are a high-level abstraction that results in one or more target policies, and that are enforceable by one or more policy engines.

According to one embodiment herein, the intermediate representation created by the intermediate representation module is a significant way to obtains the inputs from a user in a machine-readable format.

According to one embodiment herein, while converting one or more input security policies to one or more target policies, the system utilizes the Kubernetes operator, admission controller, or K8s operator policy converter.

According to one embodiment herein, the method for converting the intermediate representation into one or more target policies by the output module is provided. The method involves deploying a security intent operator in the target environment. The method further involves running one or more security intents through multiple policy engine adapters by the security intent operator, to check if there are one or more target policies in the context of one or more security intents specified by the user. In addition, the method involves returning one or more target security policies to the security intent operator if one or more target policies are available for one or more security intents.

The foregoing summary is illustrative only and is not intended to be in any way limiting. In addition to the illustrative aspects, embodiments, and features described above, further aspects, embodiments, and features will become apparent by reference to the drawings and the following detailed description.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a flowchart of a method for on-demand defense-in-depth security policy translation and enforcement, according to an embodiment herein.

FIG. 2 illustrates a block diagram of an exemplary implementation of a system for on-demand defense-in-depth security policy translation and enforcement, according to an embodiment herein.

FIG. 3 illustrates a block diagram of a security intent sample, according to an embodiment herein.

FIG. 4 illustrates a block diagram of an exemplary system for converting a security intent into a target policy, according to an embodiment herein.

FIG. 5 illustrates a flow diagram depicting the method for generating multiple target policies for different security engines, for a security intent identified in an intermediate representation, according to an embodiment herein.

FIG. 6 illustrates a flow diagram of a method for on-demand defense-in-depth security policy translation and enforcement or deployment in different sets of policy engines, according to an embodiment herein.

FIG. 7 illustrates a flow diagram of a method for converting the security intent of multiple input policies in any format to multiple target policies, according to an embodiment herein.

Although the specific features of the present invention are shown in some drawings and not in others. This is done for convenience only as each feature may be combined with any or all of the other features in accordance with the present invention.

### DETAILED DESCRIPTION OF THE EMBODIMENTS HEREIN

In the following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical, and other changes may be made without departing from the scope of the embodiments. The following detailed description is therefore not to be taken in a limiting sense.

The foregoing of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

The various embodiments herein provide a method and system for on-demand defense-in-depth security policy translation and enforcement. The embodiments herein involve converting an input security policy from any to any other format by first converting the input security policy into an intermediate representation. The intermediate representation is a way of representing the security intent. Further, converting the intermediate representation into a target policy format.

As used herein the term “Input policy” refers to a high-level security intent that is specified to match the user expectation from a security point of view.

The term “Security intent” refers to an intent specified as a K8s resource that is handled by a security intent operator.

The term “Security intent operator” refers to an operator that anticipates the security intents to be configured and converts the security intents into a set of target policies in the context of a given deployment, once the security intents are observed.

The term “Target policy” refers to the target or output policy that is specific to a given policy engine.

According to an embodiment herein, computer implemented method (100) comprising instructions stored on a no-transitory computer readable medium and executed with a hardware processor for implementing on-demand defense-in-depth security policy translation and enforcement is provided. The method comprising the steps of deriving one or more input security policies related to one or more policy engines from one or more security intents with an input module (202); creating an intermediate representation related to one or more security intents of one or more input security policies with an intermediate representation module (204); identifying one or more target policies operating in a target environment with an output module (206); converting the intermediate representation into one or more target policies with the output module (206); identifying one or more security intents, that are denied by one or more target policies with the output module (206); and creating an optional alert, for the security team to identify the difference with the output module (206), if one or more security intents are denied by one or more target policies while converting or translating the intermediate representation into one or more target policies.

According to an embodiment herein, one or more security intents are a high-level abstraction resulting in one or more target policies, and that are enforceable by one or more policy engines.

According to an embodiment herein, the intermediate representation is a significant way to obtains
the inputs from a user in a machine-readable format.

According to an embodiment herein, the method further comprises utilizes Kubernetes operator, admission controller, or K8s operator policy converter for converting one or more input security policies to one or more target policies.

According to an embodiment herein, the step for converting the intermediate representation into one or more target policies, comprises: deploying a security intent operator in the target environment; running one or more security intents through multiple policy engine adapters by the security intent operator, to check if there are one or more target policies in the context of one or more security intents specified by the user; and returning one or more target security policies to the security intent operator if one or more target policies are available for one or more security intents.

A system (200) for on-demand defense-in-depth security policy translation and enforcement, the system (200) comprises an input module (202) configured to derive one or more input security policies related to one or more policy engines from one or more security intents; an intermediate representation module (204) configured to receive one or more input security policies from the input module, and configured to create an intermediate representation related to one or more security intents of one or more input security policies; and an output module (206) configured to receive the intermediate representation, from the intermediate representation module (204), and also configured to identify one or more target policies operating in a target environment, and convert the intermediate representation into one or more target policies; and wherein the output module (206) is also configured to identify one or more security intents, that are denied by one or more target policies, and optionally create an alert for the security team to identify the difference, if one or more security intents are denied by one or more target policies while converting or translating the intermediate representation into one or more target policies.

According to an embodiment herein, wherein one or more security intents of the input module (202) are a high-level abstraction that results in one or more target policies, and that are enforceable by one or more policy engines.

According to an embodiment herein, the intermediate representation created by the intermediate representation module (204) is a significant way to obtain the inputs from a user in a machine-readable format.

According to an embodiment herein, the system (200) utilizes Kubernetes operator, admission controller, or K8s operator policy converter for converting one or more input security policies to one or more target policies.

According to an embodiment herein, the output module (206) is configured, the method for converting the intermediate representation into one or more target policies by: deploying a security intent operator in the target environment; running one or more security intents through multiple policy engine adapters by the security intent operator, to check if there are one or more target policies in the context of one or more security intents specified by the user; and returning one or more target policies to the security intent operator if one or more target policies are available for one or more security intents.

According to one embodiment herein, a method for on-demand defense-in-depth security policy translation and enforcement is provided. The method comprises deriving one or more input security policies related to one or more policy engines from one or more security intents. The method further involves creating an intermediate representation related to one or more security intents of one or more input security policies. In addition, the method involves identifying one or more target policies operating in a target environment. The method further involves converting the intermediate representation into one or more target policies. Furthermore, the method involves identifying one or more security intents, that are denied by one or more target policies, and creating an optional alert, for the security team to identify the difference, if one or more security intents are denied by one or more target policies while converting or translating the intermediate representation into one or more target policies.

According to one embodiment herein, one or more security intents are a high-level abstraction resulting in one or more target policies that are enforceable by one or more policy engines. For example, consider the intent to be: “deny execution of package management tools in the pods/workloads”. This intent can be converted into multiple policies, for example, to a policy that denies execution of package management tools such as apt, yum, dnf in the pods; a container network interface (CNI) policy that disables egress TCP connections to packages.ubuntu.com, yum.redhat.com.

apiVersion: intent.security.nimbus.com/v1
kind: SecurityIntent
metadata:
name: package-mgmt-tools
spec:
tags: [ harden]
ID: packageMgmtTool
action: block
mode: strict
severity: 1

The above security intent is passed as an input to a security intent operator, that converts the security intent into a set of target policies.

```
apiVersion: security.kubearmor.com/v1
kind: KubeArmorPolicy
metadata:
  name: harden-mysql-pkg-mngr-exec.
  namespace: wordpress-mysql
spec:
  action: Block
  message: Alert! Execution of package management process inside
  container is denied.
  process:
    matchPaths:
    - path: /usr/bin/apt
    - path: /usr/bin/apt-get
    - path: /bin/apt-get
    - path: /sbin/apk
    - path: /bin/apt
    - path: /usr/bin/dpkg
    - path: /bin/dpkg
    - path: /usr/bin/gdebi
    - path: /bin/gdebi
    - path: /usr/bin/make
    - path: /bin/make
    - path: /usr/bin/yum
    - path: /bin/yum
    - path: /usr/bin/rpm
    - path: /bin/rpm
    - path: /usr/bin/dnf
    - path: /bin/dnf
    - path: /usr/bin/pacman
    - path: /usr/sbin/pacman
    - path: /bin/pacman
    - path: /sbin/pacman
    - path: /usr/bin/makepkg
    - path: /usr/sbin/makepkg
    - path: /bin/makepkg
    - path: /sbin/makepkg
    - path: /usr/bin/yaourt
    - path: /usr/sbin/yaourt
    - path: /bin/yaourt
    - path: /sbin/yaourt
    - path: /usr/bin/zypper
    - path: /bin/zypper
  severity: 5
apiVersion: “cilium.io/v2”
kind: CiliumNetworkPolicy
metadata:
  name: “to-fqdn”
spec:
  endpointSelector:
    matchLabels:
    app: test-app
  egressDeny:
    - toEndpoints:
    - matchLabels:
      “k8s: io.kubernetes.pod.namespace”: kube-system
      “k8s: k8s-app”: kube-dns
    - toFQDNs:
    - matchName: “packages.ubuntu.com”
    - matchName: “yum.redhat.com”
```

The above example illustrates the embodiments herein can convert an input security policy into a target policy.

According to one embodiment herein, the intermediate representation is a significant way to obtains the inputs from a user in a machine-readable format.

According to one embodiment herein, while converting one or more input security policies to one or more target policies, from one format to another during deployment time, the method utilizes the Kubernetes operator, admission controller, or K8s operator policy converter.

According to one embodiment herein, the method for converting the intermediate representation into one or more target policies is provided. The method involves deploying a security intent operator in the target environment. The method further involves running one or more security intents through multiple policy engine adapters by the security intent operator, to check if there are one or more target policies in the context of one or more security intents specified by the user. In addition, the method involves returning one or more target security policies to the security intent operator if one or more target policies are available for one or more security intents.

According to one embodiment herein, a system for on-demand defense-in-depth security policy translation and enforcement is provided. The system comprises an input module configured to derive one or more input security policies related to one or more policy engines from one or more security intents. Further, the system comprises an intermediate representation module configured to receive one or more input security policies from the input module and further configured to create an intermediate representation related to one or more security intents of one or more input security policies. Moreover, the system comprises an output module configured to receive the intermediate representation, from the intermediate representation module, and further configured to identify one or more target policies operating in a target environment. The output module is further configured to convert the intermediate representation into one or more target policies. Moreover, the output module is also configured to identify one or more security intents, that are denied by one or more target policies, and optionally create an alert for the security team to identify the difference, if one or more security intents are denied by one or more target policies while converting or translating the intermediate representation into one or more target policies.

According to one embodiment herein, one or more security intents of the input module are a high-level abstraction that results in one or more target policies, and that are enforceable by one or more policy engines.

According to one embodiment herein, the intermediate representation created by the intermediate representation module is a significant way to obtain the inputs from a user in a machine-readable format.

According to one embodiment herein, while converting one or more input security policies to one or more target policies, the system utilizes the Kubernetes operator, admission controller, or K8s operator policy converter.

According to one embodiment herein, the method for converting the intermediate representation into one or more target policies by the output module is provided. The method involves deploying a security intent operator in the target environment. The method further involves running one or more security intents through multiple policy engine adapters by the security intent operator, to check if there are one or more target policies in the context of one or more security intents specified by the user. In addition, the method involves returning one or more target security policies to the security intent operator if one or more target policies are available for one or more security intents.

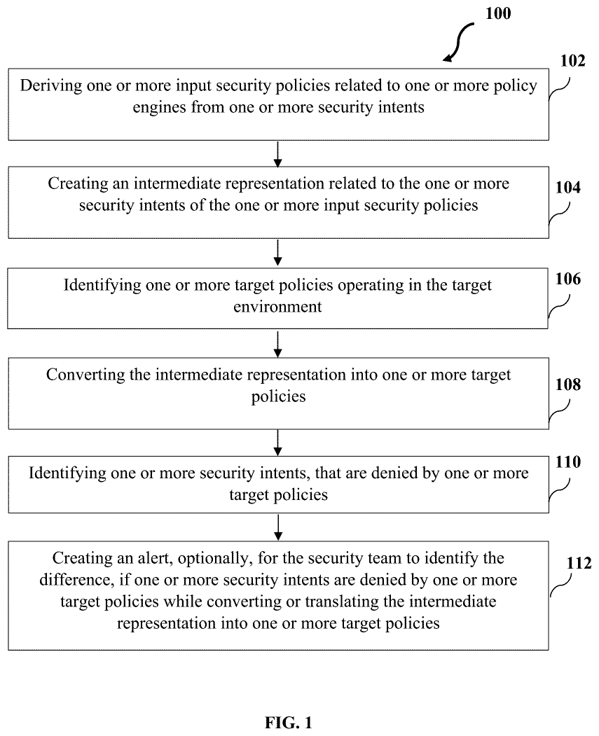

FIG. 1 illustrates a flowchart on a method for on-demand defense-in-depth security policy translation and enforcement, according to an embodiment herein. The method 100 comprises deriving one or more input security policies related to one or more policy engines from one or more security intents at step 102. The method 100 further involves creating an intermediate representation related to one or more security intents of one or more input security policies at step 104. In addition, the method 100 involves identifying one or more target policies operating in a target environment at step 106. The method 100 further involves converting the intermediate representation into one or more target policies at step 108. Furthermore, the method 100 involves identifying one or more security intents, that are denied by one or more target policies at step 110. Furthermore, the method 100 involves creating an optional alert, for the security team to identify the difference, if one or more security intents are denied by one or more target policies while converting or translating the intermediate representation into one or more target policies at step 112.

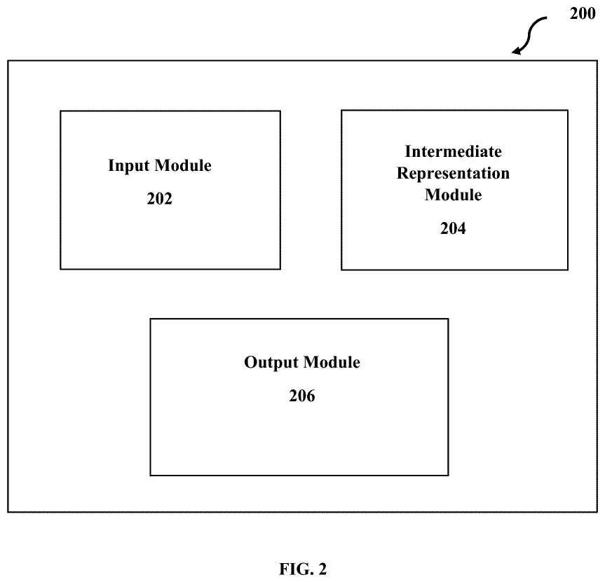

FIG. 2 illustrates a block diagram of an exemplary implementation of a system for on-demand defense-in-depth security policy translation and enforcement, according to an embodiment herein. The system 200 comprises an input module 202 configured to derive one or more input security policies related to one or more policy engines from one or more security intents. Further, the system 200 comprises an intermediate representation module 204 configured to receive one or more input security policies from the input module and further configured to create an intermediate representation related to one or more security intents of one or more input security policies. Moreover, the system 200 comprises an output module 206 configured to receive the intermediate representation, from the intermediate representation module, and further configured to identify one or more target policies operating in a target environment. The output module 206 is further configured to convert the intermediate representation into one or more target policies. Moreover, the output module 206 is also configured to identify one or more security intents, that are denied by one or more target policies, and optionally create an alert for the security team to identify the difference, if one or more security intents are denied by one or more target policies while converting or translating the intermediate representation into one or more target policies.

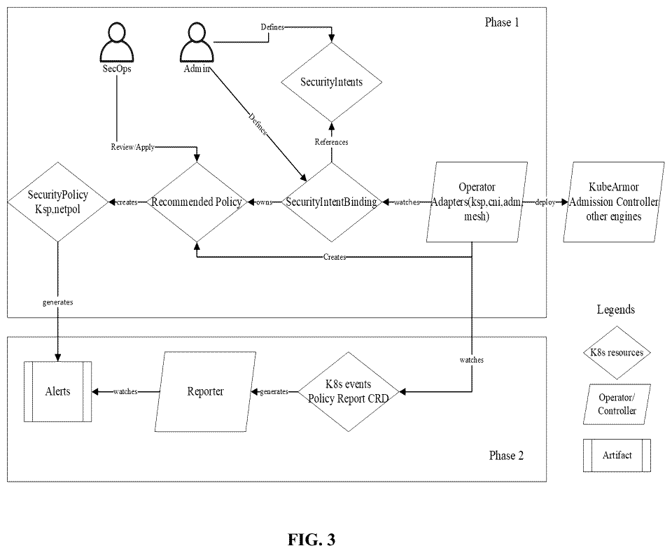

FIG. 3 illustrates a block diagram of a security intent sample, according to an embodiment herein. The security intent is a high-level abstraction resulting in one or more target policies that are enforceable by one or more policy engines. The security intent is an intent specified as a k8s resource that the security intent operator handles. The security intent operator is an operator anticipating the security intents to be configured and helps in converting the security intent into a set of target policies in the context of a given deployment, on detecting the security intent.

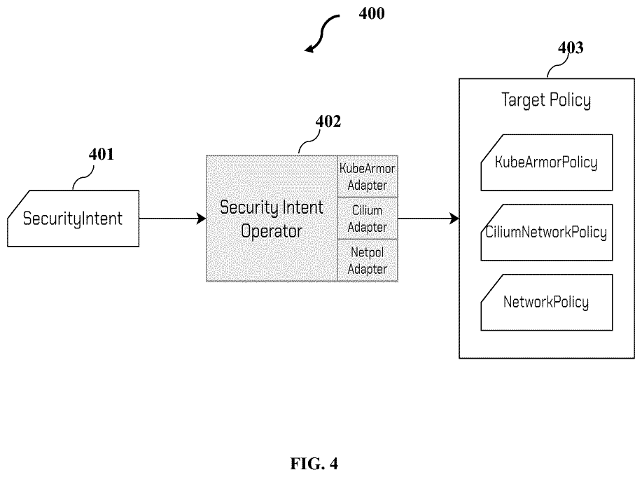

FIG. 4 illustrates a block diagram of an exemplary system for converting a security intent into a target policy, according to an embodiment herein. FIG. 4 400 illustrates a security intent operator 402 deployed in a target environment as K8s operator. Further, the security intent operator 402 runs the security intent 401 through multiple policy engine adapters to check if they have a policy in the context of the given security intent 401 when the user specifies the security intent 401. In addition, if a policy from the security intent 401 is available from a policy engine adapter of the security intent operator 402, then that policy is returned to the security intent operator 402 which applies the given policy in the target policy environment 403.

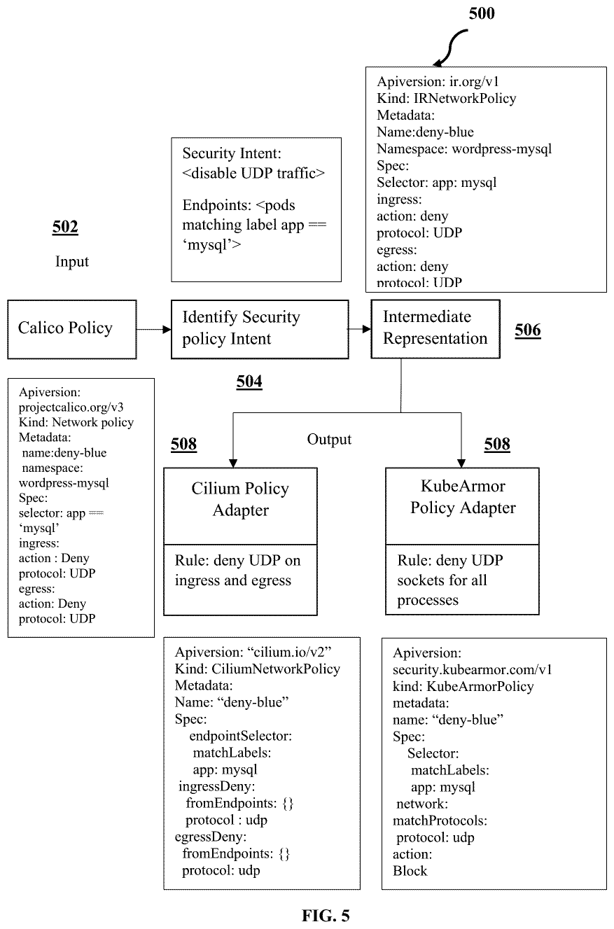

FIG. 5 illustrates a flow diagram depicting the method for generating multiple target policies for different security engines, for a security intent identified in an intermediate representation, according to an embodiment herein. The method 500 for instance, involves an input policy, Calico security policy at step 502, for which the security policy involves below snippet:

apiversion: projectcalico.org/v3
kind: NetworkPolicy
metadata:
name: deny-blue
namespace: wordpress-mysql
spec:
selector: app == ‘mysql’
ingress:
-action: deny
protocol: UDP
egress:
-action: deny
protocol: UDP

Wherein the above snippet illustrates a security intent to deny UDP protocol. Furthermore, the method 500 at step 504 identifies the security intent, which states disable UDP traffic. The method 500, further at step 506 involves creating an intermediate representation, comprising below snippet:

apiversion: ir.org/v1
kind: IRNetworkPolicy
metadata:
name: deny-blue
namespace: wordpress-mysql
spec:
selector: app == ‘mysql’
ingress:
-action: deny
protocol: UDP
egress:
-action: deny
protocol: UDP

Furthermore, the method 500, at step 508 involves creating multiple target policies, for instance cilium policy adaptor and KubeArmor policy adaptor with a rule to deny UDP on ingress and egress.

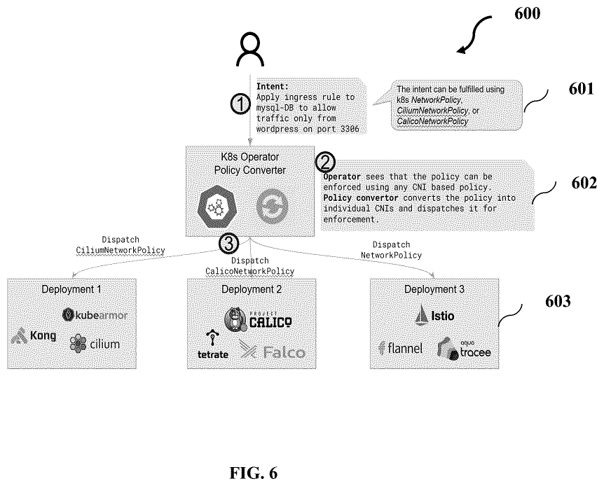

FIG. 6 illustrates a flow diagram of a method for on-demand defense-in-depth security policy translation and enforcement or deployment in different sets of policy engines, according to an embodiment herein. The method 600, at step 601 involves multiple input policies such as k8s Network Policy, Cilium Network Policy and/or Calico Network Policy, comprising a security intent: Apply ingress rule to mysql-DB to allow traffic only from word-press on port 3306. Further, the method 600, at step 602, a k8s operator policy convertor ascertains that the security intent can be enforced using any container network interface CNI-based policy. Therefore, the policy converter converts the policy into individual CNIs and dispatches it for enforcement at step 603. For instance, the method 600 comprises three deployments each containing different sets of policy engines as given in Table

TABLE 1

| De- | Network | Service Mesh | Application Protection |
|---|---|---|---|
| ployment | Engine | Engine | Engine |
| 1 | Cilium | Kong | Kube Armor |
| 2 | Calico | Tetrate | Falco |
| 3 | Flannel | Istio | Tracee |

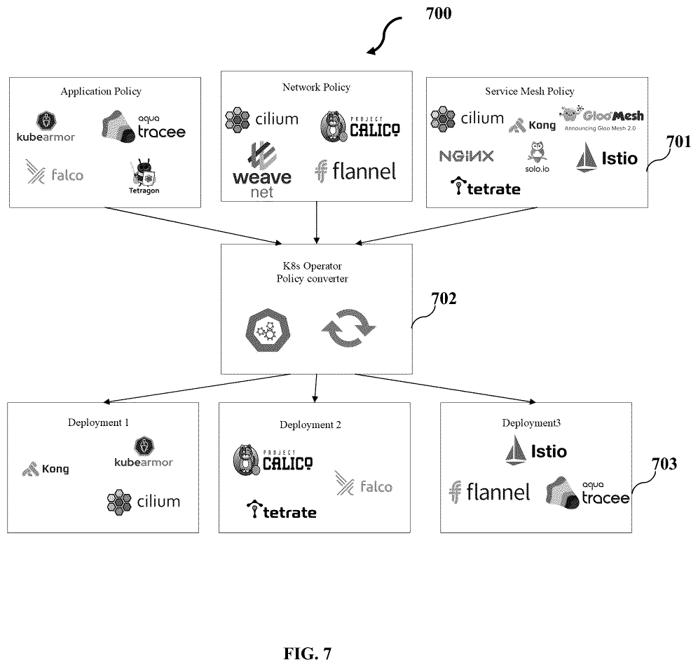

FIG. 7 illustrates a flow diagram of a method for converting the security intent of multiple input policies in any format to multiple target policies, according to an embodiment herein. The method 700 involves multiple input policies such as application policy, network policy, and Service Mesh policy at step 701. Further, the method 700 at step 702 using a k8s operator policy converter at step 702 converts the multiple input policies into multiple target policies and dispatches the multiple target policies for deployment/enforcement at step 703. For instance, deployment 1: KubeArmor, Kong and cilium; deployment 2: Calico, Tetrate, Falco; deployment 3: Istio, flannel, aqua tracee.

It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

While the disclosure is susceptible to various modifications and alternative forms, specific embodiment thereof has been shown by way of example in the drawings and will be described in detail above. It should be understood, however, that it is not intended to limit the disclosure to the forms disclosed, but on the contrary, the disclosure is to cover all modifications, equivalents, and alternatives falling within the scope of the disclosure.

The embodiments herein disclose a method and a system for on-demand defense-in-depth security policy translation and enforcement. The method comprises converting an input policy from any to any other format by first converting, the input policy into an intermediate representation. The intermediate representation is a way of representing the security intent. Further, converting the intermediate representation into a target format.

Hence, the primary objective of the embodiment herein is to convert an input policy from any to any other format by first converting it into an intermediate representation (representing the security intent) and then into a target format. Hence the embodiment herein can generate multiple target policies for different input security engines, given the security intent identified in the intermediate representation. Hence, a high-level security intent is taken as an input and then the operator checks the best way to handle the security intent in the given deployment and proposes a set of policies in the context. The embodiments herein provide a complete automation on this aspect in the form of the security intent would look like and method of generating the target policies.

Moreover, the embodiment herein by generating multiple target policies and deployment helps the security team, by not specifying the policies in individual policy engine format. Furthermore, the method is vendor-independent on deployment. Besides, the method does not require standardization or rules constructs. Therefore, the embodiment herein allows the creating multiple policies that could be enforced by different policy engines given the security intent. This provides for defense-in-depth strategy from security perspective i.e., even if one of the policy engines is compromised, the other policy engine will still be able to thwart the attack.

Although the embodiments herein are described with various specific embodiments, it will be obvious for a person skilled in the art to practice the embodiments herein with modifications.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phrases or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A computer implemented method (100) comprising; an instructions stored on a no-transitory computer readable medium and executed with a hardware processor for implementing an on-demand defense-in-depth security policy translation and an enforcement, the method comprising the steps of:
a. deriving a one or more input security policies related to a one or more policy engines from a one or more security intents with an input module (202);
b. creating an intermediate representation module (204) related to the one or more security intents of the one or more input security policies with the intermediate representation module;
c. identifying a one or more target policies operating in a target environment with an output module (206);
d. converting the intermediate representation module into the one or more target policies with the output module (206);
e. identifying the one or more security intents, denied by the one or more target policies with the output module (206); and
f. creating an optional alert, for a security team to identify a difference with the output module (206), if one or more of the security intents are denied by the one or more target policies while converting or translating the intermediate representation module into the one or more target policies.

2. The method (100) according to claim 1, wherein the one or more security intents are a high-level abstraction resulting in the one or more target policies, enforceable by the one or more policy engines.

3. The method (100) according to claim 1, wherein the intermediate representation module obtains an inputs from a user in a machine-readable format.

4. The method (100) according to claim 1, comprising a Kubernetes operator, an admission controller, or a K8s operator policy converter for converting the one or more input security policies to the one or more target policies.

5. The method (100) according to claim 1, comprising converting the intermediate representation module into the one or more target policies:
a. deploying a security intent operator in the target environment;
b. running the one or more security intents through a multiple policy engine adapters by the security intent operator, to check for the one or more target policies in the context of the one or more security intents specified by the user; and
c. returning the one or more target policies to the security intent operator if the one or more target policies are available for the one or more security intents.

6. A system (200) for an on-demand defense-in-depth security policy translation and an enforcement, the system (200) comprises:
a. an input module (202) configured to derive a one or more input security policies related to a one or more policy engines from a one or more security intents;
b. an intermediate representation module (204) configured to receive the one or more input security policies from the input module, and configured to create the intermediate representation module related to the one or more security intents of the one or more input security policies; and
c. an output module (206) configured to receive the intermediate representation module (204), configured to identify a one or more target policies operating in a target environment, and converting the intermediate representation module into the one or more target policies; and wherein the output module (206) is configured to identify the one or more security intents, denied by the one or more target policies, and optionally creating an alert for a security team to identify a difference, if the one or more security intents are denied by the one or more target policies while converting or translating the intermediate representation module into the one or more target policies.

7. The system (200) according to claim 6, wherein the one or more security intents of the input module (202) is a high-level abstraction resulting in the one or more target policies, and enforceable by the one or more policy engines.

8. The system (200) according to claim 6, wherein the intermediate representation module (204) obtains an inputs from a user in a machine-readable format.

9. The system (200) according to claim 6, wherein the system utilizes a Kubernetes operator, an admission controller, or a K8s operator policy converter for converting the one or more input security policies to the one or more target policies.

10. The system (200) according to claim 6, wherein the output module (206) is configured for converting the intermediate representation module into the one or more target policies by:
a. deploying a security intent operator in the target environment;
b. running the one or more security intents through a multiple policy engine adapters by the security intent operator, to check the one or more target policies in the context of the one or more security intents specified by the user; and
c. returning the one or more target policies to the security intent operator if the one or more target policies are available for the one or more security intents.
